(19) United States
(12) Patent Application Publication
(10) Pub. No.: US 2005/0025891 A1
(43) Pub. Date: Feb. 3, 2005

(54) Method and compositions for coating ceramic substrates

(76) Inventors: Robert H. Tang, Murrysville, PA (US); Alan E. Wang, Gibsonia, PA (US); Yingchao C. Zhang, Murrysville, PA (US); Louis J. Nehmsmann, Apollo, PA (US)

Correspondence Address: PPG Industries, Inc.;Intellectual Property Department, One PPG Place, Pittsburgh, PA, 15272, US

(21) Appl. No.: 10/895,739

(22) Filed: Jul. 21, 2004

Related U.S. Application Data
(60) Provisional application No. 60/490,209, filed on Jul. 25, 2003.

(51) Int. Cl. B05D 3/02

(52) U.S. Cl. 427/372.2

(57) ABSTRACT

A curable composition including a curable organic binder and particles is disclosed. The particles are rigid at or below a first temperature and become soft at temperatures at which the organic binder is cured. Methods for printing substrates are also disclosed.

### RELATED APPLICATION

This application claims the benefit of U.S. Provisional Application No. 60/490,209 filed Jul. 25, 2003, incorporated herein by reference.

### FIELD OF THE INVENTION

The present invention relates to coating compositions particularly suitable for coating ceramic substrates.

### BACKGROUND OF THE INVENTION

Glass and other ceramic containers utilized by the food and beverage industry are often coated with protective coatings and/or decorated with information such as the contents of the container or with fanciful markings or other indicia to identify the product and/or its source. In many countries, beverages such as beer and soda are marketed in returnable glass bottles. After the beverage has been consumed, the glass bottles are returned to the beverage filler. They are then cleaned, sterilized, refilled, relabeled, and sold again. Decals and paper labels have been used to decorate returnable beverage bottles. Both types of labels have many drawbacks. For example, both paper labels and decals are expensive, messy, and can easily come off upon exposure to water or other materials. In addition, many of the adhesives used in decals become sticky when subjected to the bottle cleaning process and can cause damage to machines, drains, and the like.

To avoid the problems associated with decals and paper labels, more permanent decorations have been applied to glass surfaces of returnable containers. These more permanent decorations are applied in the form of a paste containing finely ground particles of a glassy material (termed “frit”) and a carrier, typically a volatile organic solvent or wax (“VOC”). After application of the paste to the glass surface by hot-melt screen printing or other application techniques, the glass is fired at high temperatures (650° C., for example) to volatilize and/or thermally decompose and drive off the carrier, fuse the frit, and bind the frit to the glass surface. In hot-melt screen printing, the frit or other printing material is applied to a heated screen in a desired pattern. The frit melts or softens and then is forced through the screen via a squeegee and is transferred to the substrate for firing. Pigments insensitive to such high temperatures are included in the paste to provide color to the composition. These pigments typical contain certain heavy metals, such as cadmium for producing red color, lead for white, and chromium for yellow. The VOC and the heavy metals associated with this type of decorating process are environmental hazards. The high temperature firing step requires considerable energy consumption and poses risks of injury to workers.

Efforts to avoid using organic solvents and heavy metals in coating and/or decorating ceramic containers and to reduce energy consumption involve the use of curable organic binder systems. Conventional organic pigments are dispersed in the curable binder system that is applied to the ceramic surface in a screen printing process operated under process and temperature conditions at which any curing agent is inactive. For thermally cured organic binders the decorated container is heated in an oven to a temperature that activates the curing agent to cure the binder but that does not degrade the pigment; this serves to fix the binder with pigment to the container. However, if the application of a second layer is desired, a subsequent screening application often peels the previously applied color layer from the container, or this color layer is otherwise damaged, resulting in defective product. If the first layer is cured or partially cured before the application of the second layer, peeling and other damage during application of subsequent layer(s) are avoided but with the significant detriment of process speed, efficiency and/or energy use.

Binders cured via UV radiation can be used to prepare multi-ink designs which avoid damage to underlying layers by curing (or partially curing) each ink layer prior to application of the next. However, this requires the installation of a UV curing station after each ink application station adding to the cost and complexity of the equipment.

Accordingly, there is a need for compositions and methods for coating ceramic containers that provide excellent decorative effect, are cost competitive, and/or minimize energy consumption.

### SUMMARY OF THE INVENTION

The present invention is directed to curable compositions comprising at least one curable organic binder and a plurality of particles that are rigid at or below a first temperature and soften at or below the temperature at which the organic binder cures. Methods for coating ceramic substrates using one or more curable compositions are also within the present invention.

### DETAILED DESCRIPTION OF THE INVENTION

The present invention is directed to compositions that are particularly suitable for coating ceramic substrates. “Ceramic” refers to a wide range of substrates generally characterized as brittle, heat resistant, and/or formed from one or more non-metallic minerals, including but not limited to, pottery, earthenware, clay, whiteware, refractories, porcelain, glass ceramic and glass. The ceramic substrates can be glazed or unglazed, and can be in any shape, size or configuration.

The compositions of the present invention comprise at least one curable organic binder and a plurality of particles that are rigid at or below a first temperature and soften at a higher second temperature at or below the temperature at which the binder cures; the binder remains uncured at the first temperature. The compositions of the present invention may be colored or colorless; they may be opaque or clear. The compositions of the present invention are particularly suitable for applying to ceramic substrates using hot-melt screen printing processes, although the invention is not so limited.

In certain nonlimiting embodiments, the components of the present compositions are selected so that the binder is uncured and the particles are rigid at a first temperature. “Rigid” and like terms mean that the particles are not readily compressible at a given temperature; that is, the particles have greater structural integrity than the uncured binder in which they are contained at the first temperature. The first temperature will typically be the temperature at which the composition is applied to the substrate and/or the temperature at which a second or subsequent coating layer may be applied to the substrate. This may be room temperature, or it may be at somewhat elevated temperatures. At a second temperature, the binder cures and the particles soften. “Cure” and like terms refer to chemical reactions that link together the various components of the organic binder forming a thermoset polymer. “Soften” and like terms refer to the loss of sufficient rigidity of structure in the particles such that a deformation and/or other shape change occurs in the particles. For example, particles protruding from the surface of the compositions of the present invention change shape at or below the second temperature, “melting” or smoothing the coating surface; because of this smoothing, the gloss reduction normally observed when particles protrude through a coating surface is minimized if not eliminated. As such, the compositions of present invention differ from other coating systems containing particles that maintain their rigidity and/or structural integrity. The compositions and methods of the present invention are particularly suitable for applying a plurality of coatings, including decorations, to a ceramic substrate, such as producing multiple colors or multiple coating layers on the substrate.

The binders used according to the present invention may be selected from any suitable organic coating compositions known in the art. These include compositions that contain an organic, resinous component, such as one that is capable of being printed onto a ceramic substrate in a substantially liquid state and thereafter cured to a durable, hardened state. Cure can be accomplished by any means, such as heat, UV radiation, electron beam radiation or some other form of energy that causes the binder to cure. In one nonlimiting embodiment, the binder includes one or two organic components that undergo a curing reaction when the curing energy is applied. In certain nonlimiting embodiments, the composition can comprise an epoxy resin and an amine curing agent (e.g., dicyandiamide) such as those disclosed in U.S. Pat. No. 6,214,414, and in another nonlimiting embodiment of the invention, the binder can further include a blocked isocyanate curing agent as is also disclosed in U.S. Pat. No. 6,214,414, incorporated herein by reference. Other suitable resins include, for example, hydroxyl or carboxylic acid containing acrylic polymers, hydroxyl or carboxylic acid-containing polyester polymers, isocyanate or hydroxyl containing polyurethane polymers, amine or isocyanate containing polyureas, or any other hydroxy, carboxylic acid, amide, amine carbamate, isocyanate or epoxy functional polymers. Suitable curing agent(s) can be determined by one skilled in the art and may include one or more of aminoplasts, phenoplasts, polyepoxides, polyacids, isocyanates, polyols, polyamines, anhydrides, and carbodiimides.

In one nonlimiting embodiment, a polyepoxy-functional reactive organic resin may be used; “polyepoxy-functional” means that on a number average molecular weight basis, the resin contains, on average, more than one epoxy group per molecule or, on average, approximately two hydroxyl groups per molecule or more. In other nonlimiting embodiments, UV radiation or electron beam (EB) radiation can be used to initiate curing of suitably formulated binders that contain reactive functionality designed to thermoset upon exposure to the radiation. These include various free radical cure materials such as acrylates, vinyl functional materials, acrylated oligomers and polymers, vinyl ether with unsaturated polyester. They can also be cationically initiated materials such as cycloaliphatic epoxy or vinyl ether. Suitable free radical or cationic photoinitiators are generally used with UV curing and are optional for EB curing. Combinations of free radical and cationic curing are also possible, as are combinations of the UV/EB cure processes with the thermal cure compositions described above.

In certain nonlimiting embodiments, the binders used in the present invention have or are adapted to have viscosities suitable for printing at temperatures of 60° C. to 120° C.; other temperatures can be used in other nonlimiting embodiments. For thermally cured systems, the curing mechanisms of the binders are selected so as to have little or no activation until they are subjected to the second temperature, at which the binder cures. In order to avoid premature curing, the difference between the first and second temperatures can be at least 30° C., and more typically greater than 50° C., although other temperature differences can be used within the present invention.

In some applications, it is desirable that the binder adheres to the ceramic substrate at a level that approaches or achieves a permanent coating on the substrate. Such high durability coatings are often desired for containers that undergo repeated caustic washing (e.g. in alkaline solutions) as is commonly employed by bottlers for cleaning returned bottles prior to refilling. The bottles may be treated with an adhesion promoter prior to application of the decorating compositions of the present invention or the binder may include an adhesion promoter such as an organo-functional silane, siloxane or titanate.

In other applications, the coating may be removed from the container after a limited number of return trips to the beverage bottler. For example, seasonal or holiday decorations may be placed on bottles during a promotional period and removed at the conclusion of the promotional period. The ceramic substrate may be treated with a release-enhancing composition prior to application of the compositions of the present invention. One nonlimiting example of a composition for treating ceramic substrates to enhance release of the coating compositions of the present invention in a caustic wash is a polyethylene composition such as a polyethylene emulsion. The release-enhancing composition may be applied in a cold end coating process.

As noted above, the particles incorporated in the compositions of the present invention are rigid at or below a first temperature and soften at a second temperature that is higher than the first; the particles are typically organic polymeric materials. The particles have substantial structural rigidity at the temperatures at which the composition is applied to a surface, which in the case of hot-melt type compositions can be significantly elevated, but lose their structural distinctness at the temperatures used for curing the binder. The initial rigidity need not preclude all resiliency or plasticity, but is sufficient to provide structural integrity to an applied, uncured layer of the coating composition. This structural integrity permits applying subsequent layer(s) to the substrate without the need to cure each layer. In this manner, the particles function as “spacers” that retain the coating at substantially the desired location until cure. Because of the integrity of the prior-applied layer or layers, the invention permits two or more coating layers, such as coatings of different colors, to be applied without a curing step between the application of the different layers.

After all of the desired layers have been applied, curing energy may be applied to substantially cure all of the layers substantially simultaneously. “Substantially cure” and like phrases means that the binder is more than partially cured. “Substantially simultaneously curing” and like phrases refer to substantial curing of all layers in a single cure step. This is a significant advantage of the present invention.

Organic particles suitable for use in the present invention may comprise a wide variety of polymeric species and blends thereof, provided that they exhibit the combination of rigidity and thermal softening described above. Organic particles are particularly beneficial in achieving the desired level of gloss in the present compositions because they readily soften and flow resulting in a smooth, glossy surface. Examples of suitable polymeric materials include polyamides, polysiloxanes, polyacrylates, polyacrylamides, polystyrene, polyurethane and polyester. Nonlimiting examples of suitable polyamides include polyamide 12, polyamide 11, and polyamide 6/12.

In addition to these organic particles, the present coating can further include inorganic particles and other organic particles that may not possess the softening properties of the organic particles as discussed above. Such particles may be useful in achieving other objectives such as surface texture, coefficient of friction, abrasion resistance and/or special reflectivity. If present, such inorganic or other organic particles are present at levels and ratios sufficient to exhibit a desired effect in the coating composition.

For a typical commercial bottle decorating process that uses hot-melt screen printing temperatures ranging from 60° C. to 120° C., and cure temperatures ranging from 150° C. to 220° C., it has been found that particles of polyamide 12 are particularly suitable. Other polymer systems may be particularly suitable with different temperature ranges.

In addition to temperature parameters, particles may selected for use based on their solubility and/or wettability in the binder and/or remainder of the composition. Particles that are overly soluble in the binder may dissolve, swell or soften therein and not function as spacers at the printing temperature or otherwise result in undesired surface appearance. If the particles are not sufficiently wetted by the binder, an undesirable surface texture can result.

The particles may be spherical or non-spherical particles. The average size and distribution of particle sizes is chosen to maximize the spacer function and minimize any deleterious effect on appearance. Particle sizes vary according to the needs and desires of the user, and may have an average particle diameter of less than 1 micron. In certain nonlimiting embodiments, average particle diameters may be at least 1 micron, in other nonlimiting embodiments at least 3 microns, and average diameters of at least 5 microns have been found to be satisfactory in some nonlimiting embodiments. The size of the particle will typically be approximately the same size as the coating layer being deposited. If the particles are too small relative to the coating layer, they will not function as spacers and if they are too large, they may protrude, even after softening, from the surface and reduce the final gloss of the coating or decoration. Selection of particle size may also be determined by the mesh size of the screen used in a hot-melt screen printing process. The screen may become plugged by particles that are too large to pass therethrough, which results in poor printing quality.

Typically, the binder will comprise 20 to 95 weight percent, such as 35 to 65 weight percent, with weight percent based on the total weight of the compositions. In certain nonlimiting embodiments, the relatively small sizes and amounts of particles used in the decorating compositions of the present invention do not produce perceptible reflectivity as in some compositions of other types that contain microspheres. The particle content of the compositions is typically in the range of 5 to 50 weight percent, or 10 to 35 weight percent, or 15 to 30 weight percent, with weight percent based on total weight of the composition. The density, particle size and particle size distribution will determine the quantity appropriate to achieve satisfactory spacer function and the desired film appearance. For example, it will be appreciated that a greater weight percent of particles may be needed for particles that are relatively dense in order to achieve an effect similar to when less dense particles are used.

Colorants may optionally be used in formulating the present compositions and may include finely divided solid powders, insoluble but wettable under the conditions of use. They may be pigments or dyes and confer substantial color (which includes white, black and gray) to the compositions of the invention and to coatings formed from such compositions.

Color-imparting pigments are known to those of skill in the art, and a list of specific examples can be found in U.S. Pat. No. 6,214,414. A single colorant or a mixture of two or more colorants may be used. Pigments that are resistant to high temperatures, such as those used in frit coatings and decorations, often containing heavy metals, can be used, but because high temperatures are not necessary in the present invention, pigments that do not have high temperature resistance can be used. Thus, the present invention offers an advantage in that heavy metal-containing pigments, which are often toxic, can be avoided without sacrificing appearance. One nonlimiting embodiment of the present invention specifically excludes heavy metals including chromium, cadmium, lead or cobalt. The colorants, if used, may comprise from 1 to 65 weight percent of the present compositions, such as from 3 to 40 weight percent or 5 to 35 weight percent with weight percent based on the total weight of the compositions. Any pigments or dyes that are typically used in the paint industry can be incorporated such as titanium dioxide, carbon black, DPPBO red, phthalo green or blue, iron oxide, bismuth vanadate, napthol AS, anthraquinone, perylene, aluminum and quinacridone.

The composition may also include special effect pigments that produce one or more effects such as reflectance, pearlescence, metallic sheen, phosphorescence, fluorescence, photochromism, thermochromism, and goniochromism. The special effect pigments may or may not impart color to the compositions.

Reactive waxes can optionally be included in certain nonlimiting embodiments of the present invention. These are long-chain aliphatic substances that have at least one reactive group having an active hydrogen, usually selected from hydroxyl, amido, ureylene, carbamyl, and carbamyloxy, and which have the physical characteristics commonly associated with waxes. Stearyl alcohol is an example of a reactive wax that is commonly used, but many other compounds are known in the art. Reactive wax may optionally constitute up to 20 percent by weight of the composition, such as from 0.5 to 15 percent by weight of the compositions.

Certain nonlimiting embodiments of the present compositions may include substantially clear and/or substantially colorless fillers, and are particularly suitable for use in a substantially clear composition. These fillers generally are finely divided particulate solids that impart little or no color to the final coatings (are “substantially colorless”) and/or absorb little or no visible light (are “substantially clear”). They may be used in addition to the organic particles of the present invention. The fillers usually have a maximum dimension of less than 500 nanometers, such as less than 100 nanometers, less than 50 nanometers, less than 20 nanometers or in the range of 5 to 20 nanometers. In certain nonlimiting embodiments, the fillers are hydrophobic. Examples of suitable hydrophobic fillers include AEROSIL fumed silicas designated R972, R974, R812, R812S, R805 (Degussa Corporation, Ridgefield Park, N.J.). A substantially clear and/or colorless filler or a mixture of two or more substantially clear and/or colorless fillers may be used when desired. When present in the present compositions, the substantially clear and/or colorless filler(s) typically comprise from 0.01 to 20 percent by weight of the composition, such as from 1 to 10 percent, or 2 to 5 percent.

Many other additional materials may be optionally used in the present compositions. Among these are antioxidants, degassing aids and flow modifiers. These are only exemplary; others may be used as desired. Other additives may be included for improving rheology, opacity, durability, lubricity, color brightness, and many other functions known to those of skill in the art. When present, the additional optional materials can be used in their customary amounts for their customary purposes. Typically, these additional optional materials, when present, will constitute from 0.01 to 15 weight percent of the present coating compositions.

The present invention is also directed to a method of coating a ceramic substrate by applying at least one of the coating compositions described above to a ceramic substrate. The coating is applied to at least a portion of the substrate or onto a previously applied coating layer, both being referred to herein as the substrate. The coating may be applied in the form of discrete words or designs on the substrate, or can cover large portions or all or substantially all of the substrate. According to the present invention, two or more different coating layers can be applied to a substrate. A “coating layer” or a “decorating layer” generally refers to a single composition layer that may impart a color of a label or a clear portion of a label. When a second coating layer is applied over, adjacent to, and/or spaced apart from a first coating layer, the particles in the first coating layer maintain the integrity of the uncured first layer by functioning as spacers. Thus, application of subsequent coating layers on top of, adjacent to and/or spaced apart from the previously applied coating layers does not disturb the previously applied coating layers. The last layer to be applied may also contain the particles, but since it is not subjected to the rigors of a subsequent printing operation, it need not include the particles of the coating compositions of the present invention. One or more of the layers may be produced from compositions containing colorants or may be produced from substantially clear compositions. In certain nonlimiting embodiments, substantially clear layers may be used as an initial coating on the substrate or as a clear overcoating covering at least a portion of colored layers. In accordance with the present invention, a multi-colored, organic decoration can be applied to a ceramic substrate in a plurality of printing steps in rapid succession. When more than one coating layer is used, each coating layer can be the same or different as other coating layers. After all the coating layers have been applied, the coated substrate is heated to an elevated temperature to cure all of the applied coating layers substantially simultaneously. In compositions that include blocked isocyanates, curing of one or more of the applied coating compositions is accomplished at temperatures sufficiently to unblock the polyisocyanates. With amine-cured epoxy based systems, curing temperatures in typical commercial bottle decorating operations are usually at least 150° C. and may be as high as 200° C. The curing temperature should not be so high as to cause unwanted coloration or other thermal degradation of the coatings. Different curing temperatures will be applicable for other resin systems or other processes. In certain nonlimiting embodiments, two or more compositions as described herein are applied to at least a portion of the substrate and the compositions are substantially simultaneously cured at temperatures at or below 325° C.

As noted above, the compositions of the present invention may be applied to an undecorated ceramic substrate and/or to a substrate that has had one or more previously applied layers of the same or similar compositions. In the latter situation, it will be appreciated that the subsequent coating layer may be applied directly to the substrate, at least partially over one or more other coating layers, or some combination thereof; “applying to at least a portion of the substrate” and like terms encompass all of these alternatives since all decorating layers are ultimately being applied to the substrate. Usually, the layers are applied at elevated temperatures so that the chilling effect of the cooler substrate will quickly substantially solidify the coating layer. Such solidification is helpful in maintaining fine-line definition, in permitting application of multiple layers without impairing the definition of any previously applied layer, and/or in permitting application of multiple layers without having to cure each layer separately. In certain nonlimiting embodiments, it may be desired for the application temperature of a subsequently applied layer to be lower than the temperature at which a previously applied coating will liquefy or unduly soften. This enhances preservation of the fine-line definition and resolution of the previously applied decorating layer. The present methods are particularly suitable for applying brand indicia to glass bottles, or in any other application in which definition, such as with lettering, is particularly desired.

The decorating compositions generally rapidly solidify to the touch after application. As such, they can be advantageously used in decorating lines operating at high speeds where bottles or other ceramic substrates are sequentially coated.

The present invention is typically described herein using application by hot-melt screen printing. It will be appreciated that the present invention includes any process for applying a coating such as spraying, curtain coating, roller application, printing, or brushing.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### EXAMPLES

The invention is further described with the following examples, which are to be considered illustrative rather than limiting, and in which all parts are parts by weight and all percentages are percentages by weight unless otherwise specified. The following materials were used in the examples:
EPON 880 bisphenol A diglycidyl ether, Resolution Performance Products, Houston, Tex.
EPON 1001 F bisphenol A diglycidyl ether, Resolution Performance Products, Houston, Tex.
VESTAGON B 1400, blocked polyisocyanate believed to be an adduct of isophorone diisocyanate, 1,1,1-trimethylolpropane, and ε-caprolactam in a 3:1:3 molar ratio, Degussa AG, Coatings and Colorants, Marl, Germany.
TI-PURE R-706 titanium dioxide pigment, E.I. du Pont de Nemours & Co., Wilmington, Del.
NEO GEN DGH aluminum silicate, Dry Branch Kaolin Co., Dry Branch, Ga.
SPHERICEL 110P8 hollow borosilicate glass microspheres, 11.7 microns mean diameter, Potters Industries, Inc., Valley Forge, Pa.
MODAFLOW Powder III flow modifier—ethyl acrylate-2-ethylhexyl acrylate copolymer with silicon dioxide, Solutia Inc., St. Louis, Mo.
UVITEX OB whitening agent, 2,2′-(2,5-thiophenediyl)bis[5-(1,1-dimethylethyl)]-benzoxazole, Ciba Specialty Chemicals, Basil, Switzerland.
BYK-405 rheology control agent, solution of polyhydroxycarboxylic acid amides, BYK-Chemie, Wesel, Germany.
DYHARD 100M dicyandiamide, micronized 98% <40 microns, SKW Trostberg Aktiengesellschaft, Trostberg, Germany.
AEROSIL R974 hydrophobic fumed silica, Degussa AG, Frankfort am Main, Germany.
ORGASOL 1002 D NAT 1 polyamide 6 powder, 20 micron average particle diameter, Atofina Chemicals, Philadelphia, Pa.
ORGASOL 2001 UD NAT 1 polyamide 12 powder, 5 micron average particle diameter, Atofina Chemicals, Philadelphia, Pa.
VESTOSINT 2070 polyamide 12 powder, 5 micron average diameter, Degussa AG, Marl, Germany.
DOVERPHOS S-680 distearyl pentaerythritol diphosphite antioxidant from Dover Chemical Corporation, Dover, Ohio.
FLUORAD Fluorosurfactant FC 4430 non-ionic polymeric surfactant from 3M Specialty Materials, St. Paul, Minn.
INTERPROME 4049 azo based naphthol red colorant from Sino P.R. China.
INTERPROME 4047 pigment from Sino, P.R. China.

### Example 1

A white decorating composition in accordance with one embodiment of the present invention was prepared using organic particles (VESTOSINT 2070 polyamide 12 powder). The materials of Charge 1 were mixed at 80° C. to 110° C. until homogenous. The materials of Charge 2 were introduced into the mixture of Charge 1 and mixed for one hour at 80° C. to 110° C. to give a white homogenous paste. The resulting white decorating composition was poured into a container and allowed to cool to room temperature to yield a solid coating composition.

| | | |
|---|---|---|
| Component | Weight, g | % wt |

Charge 1

| | | |
|---|---|---|
| EPON 880 | 50.00 | 25.08 |
| EPON 1001 F | 60.00 | 30.10 |
| Stearyl alcohol | 10.00 | 5.02 |

Charge 2

| | | |
|---|---|---|
| TiO₂ | 32.00 | 16.05 |
| Blue Dye | 0.1355 | 0.07 |
| Violet Dye | 0.9184 | 0.46 |
| DOVERPHOS S-680 | 1.01 | 0.51 |
| VESTOSINT 2070 | 32.53 | 16.32 |
| MODAFLOW Powder III (65%) | 4.00 | 2.01 |
| UVITEX OB | 1.00 | 0.50 |
| DYHARD 100 M | 7.73 | 3.88 |

### Example 2

A white decorating composition in accordance with one embodiment of the present invention was prepared, using a combination of organic particles (VESTOSINT 2070 polyamide 12 powder) and inorganic particles (SPHERICEL 110P8 glass beads). The materials of Charge 1 were mixed at 80° C. to 110° C. until homogenous. The materials of Charge 2 were introduced into the mixture of Charge 1 and mixed for one hour at 80° C. to 110° C. to give a white homogenous paste. The resulting white decorating composition was poured into a container and allowed to cool to room temperature to yield a solid coating composition.

| | | |
|---|---|---|
| Component | Weight, g | % wt |

Charge 1

| | | |
|---|---|---|
| EPON 880 | 45.00 | 21.72 |
| EPON 1001 F | 65.00 | 31.37 |
| Stearyl alcohol | 20.00 | 9.65 |

Charge 2

| | | |
|---|---|---|
| TiO₂ | 32.00 | 15.45 |
| Blue Dye | 0.1350 | 0.07 |
| Violet Dye | 0.9180 | 0.44 |
| SPHERICEL 110P8 | 10.00 | 4.83 |
| DOVERPHOS S-680 | 1.04 | 0.50 |
| VESTOSINT 2070 | 20.71 | 10.00 |
| MODAFLOW Powder III (65%) | 4.00 | 1.93 |
| UVITEX OB | 1.00 | 0.48 |
| DYHARD 100 M | 7.37 | 3.56 |

### Example 3

A white decorating composition in accordance with one embodiment of the present invention was prepared using organic particles (ORGASOL 2001 UD NAT1 polyamide 12 powder). The materials of Charge 1 were mixed at 80° C. to 110° C. until homogenous. The materials of Charge 2 were introduced into the mixture of Charge 1 and mixed for one hour at 80° C. to 110° C. to give a white homogenous paste. The resulting white decorating composition was poured into a container and allowed to cool to room temperature to yield a solid coating composition.

| | | |
|---|---|---|
| Component | Weight, g | % wt |

Charge 1

| | | |
|---|---|---|
| EPON 880 | 50.00 | 25.66 |
| EPON 1001 F | 55.00 | 30.79 |
| Stearyl alcohol | 10.00 | 5.13 |

Charge 2

| | | |
|---|---|---|
| TiO₂ | 32.00 | 16.42 |
| Blue Dye | 0.14 | 0.07 |
| Violet Dye | 0.92 | 0.47 |
| DOVERPHOS 5-680 | 0.98 | 0.50 |
| ORGASOL 2001 UD NAT1 | 28.12 | 14.43 |
| MODAFLOW Powder III (65%) | 4.00 | 2.05 |
| UVITEX OB | 1.00 | 0.51 |
| DYHARD 100 M | 7.73 | 3.96 |

### Example 4

A white decorating composition was prepared incorporating only inorganic particles (SPHERICEL 110P8 hollow glass microspheres). The materials of Charge 1 were mixed at 80° C. to 110° C. until homogenous. The materials of Charge 2 were introduced into the mixture of Charge 1 and mixed for one hour at 80° C. to 110° C. to give a white homogenous paste. The resulting white decorating composition was poured into a container and allowed to cool to room temperature to yield a solid coating composition.

| | | |
|---|---|---|
| Component | Weight, g | % wt |

Charge 1

| | | |
|---|---|---|
| EPON 880 | 50.00 | 25.08 |
| EPON 1001 F | 60.00 | 30.10 |
| Stearyl alcohol | 10.00 | 5.02 |

Charge 2

| | | |
|---|---|---|
| TiO₂ | 32.00 | 16.05 |
| SPHERICEL 110P8 | 32.53 | 16.32 |
| MODAFLOW Powder III | 4.00 | 2.01 |
| UVITEX OB | 1.00 | 0.50 |
| DYHARD 100 M | 7.73 | 3.88 |
| DOVERPHOS S-680 | 1.01 | 0.51 |
| Blue Dye | 0.1355 | 0.07 |
| Violet Dye | 0.9184 | 0.46 |

### Example 5

A red decorating composition was prepared for overprinting onto the white decorations of Examples 1 through 4. The decorating composition did not include the particles, since it was applied as a subsequent decorating layer. The materials of Charge 1 were mixed at 80° C. to 110° C. until homogenous. The mixture was further mixed at 80° C. to 110° C. for one hour to produce a red homogenous paste. The resulting red decorating composition was poured into a container and allowed to cool to room temperature to yield a solid coating composition.

| | | |
|---|---|---|
| Component | Weight, g | % wt |

Charge 1

| | | |
|---|---|---|
| EPON 880 | 55.00 | 36.89 |
| EPON 1001 F | 45.00 | 30.19 |
| Stearyl alcohol | 10.00 | 6.71 |
| VESTAGON B1400 | 10.00 | 6.71 |

Charge 2

| | | |
|---|---|---|
| INTERPROME 4049 | 4.00 | 2.69 |
| INTERPROME 4047 | 8.00 | 5.36 |
| TiO₂ | 3.00 | 2.01 |
| Fluorosurfactant FC 4430 | 0.50 | 0.34 |
| MODAFLOW Powder III | 3.00 | 2.01 |
| DOVERPHOS S 680 | 0.74 | 0.50 |
| BYK 405 | 0.56 | 0.38 |
| DYHARD 100 M | 7.88 | 5.29 |
| AEROSIL R974 | 1.40 | 0.94 |

This red ink was successfully printed over each of the prior white ink examples using a Strutz 150 decorating machine as part of the typical multi-ink application process. The resulting bottle decorations, when cured in a single-step baking process for 45 minutes at 350° F., provided acceptable appearance and film performance properties.

### Example 6

### Gloss Measurement

The white compositions prepared in Examples 1 through 4 were printed as a design on glass bottles using a Strutz GP-4 Semi-Automatic General Purpose Decorator. A stainless steel screen of 180 mesh was used and the white decorating compositions were printed at temperatures in the range of from 80° C. to 85° C. The printed bottles were subsequently cured in a forced air oven at 180° C. for one hour. The surface gloss of the decoration was determined by a Novo-Curve small area glossmeter (from Rhopoint Instrumentation Ltd., East Sussex, United Kingdom), which is adapted to carry out the procedure of ASTM D523. The surface gloss of the compositions of the present invention (Examples 1-3) was greater than that of Example 4.

| Example | Gloss, 60° |
|---|---|
| 1 | 43 |
| 2 | 34 |
| 3 | 37 |
| 4 | 23-28 |

Although the present invention has been described with reference to specific details of certain embodiments thereof, it is not intended that such details should be regarded as limitations upon the scope of the invention except insofar as they are included in the accompanying claims.

1. A curable composition comprising at least one curable organic binder and a plurality of particles that are rigid at or below a first temperature and that soften at a second temperature at or below the temperature at which the binder cures.

2. The composition of claim 1, wherein the difference between the first temperature and the second temperature is at least 30° C.

3. The composition of claim 1, wherein the difference between the first temperature and the second temperature is at least 50° C.

4. The composition of claim 1, wherein at least some of the particles comprise an organic material.

5. The composition of claim 4, wherein the organic material is a polyamide.

6. The composition of claim 4, further comprising inorganic particles and/or other organic particles.

7. The composition of claim 1, wherein the particles comprise 5 to 50 wt. % of the composition.

8. The composition of claim 1, wherein the particles comprise 10 to 35 wt. % of the composition.

9. The composition of claim 1, wherein the curable organic binder comprises a polyepoxy-functional reactive resin.

10. The composition of claim 9, wherein the binder further comprises an amino-functional curing agent.

11. The composition of claim 9, wherein the curable organic binder further comprises a blocked polyisocyanate.

12. The composition of claim 1 further comprising a colorant.

13. The composition of claim 12, wherein the colorant comprises an organic pigment.

14. The composition of claim 12, wherein the colorant comprises an inorganic pigment.

15. The composition of claim 1, further comprising a special effect pigment.

16. A method for coating a ceramic substrate comprising:
(a) applying to at least a portion of the substrate a composition comprising at least one curable organic binder and a plurality of particles that are rigid at or below a first temperature and soften at a second temperature at or below the temperature at which the binder cures; and
(b) curing the binder to form a coating layer.

17. A method for coating a ceramic substrate comprising:
a) successively applying to at least a portion of the substrate two or more compositions, each of said compositions comprising at least one curable organic binder and a plurality of particles that are rigid at or below a first temperature and soften at a second temperature at or below the temperature at which the binder of the composition cures, wherein each composition may be the same as or different from other composition(s) and wherein the last of said compositions only optionally comprises said plurality of particles; and
(b) substantially simultaneously curing the binders in the compositions to form coating layers.

18. The method of claim 16, wherein the composition further comprises a colorant.

19. The method of claim 17, wherein at least one of the compositions further comprises a colorant.

20. The method of claim 16, wherein the curable organic binder comprises a polyepoxy-functional reactive organic resin.

21. The method of claim 20, wherein the curable organic binder further comprises a blocked polyisocyanate.

22. The method of claim 17, wherein the curable organic binder comprises a polyepoxy-functional reactive organic resin.

23. The method of claim 22, wherein the curable organic binder further comprises a blocked polyisocyanate.

24. The method of claim 16, wherein said applying step comprises hot-melt screen printing said composition onto said substrate.

25. The method of claim 17, wherein said applying step comprises hot-melt screen printing said compositions onto said substrate.

26. The method of claim 16, wherein the ceramic substrate is glass.

27. The method of claim 17, wherein the ceramic substrate is glass.

28. The method of claim 16, further comprising, prior step (a), treating the ceramic substrate with a composition for enhancing the releasability of the cured composition from the substrate.

29. The method of claim 17, further comprising, prior step (a), treating the ceramic substrate with a composition for enhancing the releasability of the cured composition from the substrate.

30. The method of claim 28, wherein the composition for enhancing the releasability of the cured composition from the substrate comprises polyethylene.

31. The method of claim 29, wherein the composition for enhancing the releasability of the cured composition from the substrate comprises polyethylene.

32. The method of claim 16, wherein the ceramic substrate is a glass bottle.

33. The method of claim 17, wherein the ceramic substrate is a glass bottle.

34. A ceramic substrate coated according to the method of claim 16.

35. A ceramic substrate coated according to the method of claim 17.

36. A ceramic substrate coated according to the method of claim 28.

37. A ceramic substrate coated according to the method of claim 29.

38. A method for coating a ceramic substrate comprising:
(a) apply two or more compositions to said substrate; and
(b) substantially simultaneously curing the compositions at temperatures at or below 325° C.
